(19) United States
(12) Patent Application Publication
(10) Pub. No.: US 2003/0198138 A1
(43) Pub. Date: Oct. 23, 2003

(54) Prayer clock

(76) Inventor: Ali Shebani, Chernex (CH)

Correspondence Address: YOUNG & THOMPSON, 745 SOUTH 23RD STREET 2ND FLOOR, ARLINGTON, VA, 22202

(21) Appl. No.: 10/379,798

(22) Filed: Mar. 6, 2003

(30) Foreign Application Priority Data
Mar. 8, 2002 (EP) 02005169.4

(51) Int. Cl. G04B 19/22; G04C 11/02

(52) U.S. Cl. 368/21; 368/47

(57) ABSTRACT

A clock having a time display unit (2) with an hour and a minute indication and a control unit (4). The clock comprises elements for signaling a plurality of times of occurrence of certain events during the course of the day and elements for determining the occurrence times of the events dependent on information related to a given location.

The present invention refers to a multifunctional clock that serves as local time indicator, indicates and warns the user at the occurrence of prayers during the course of the day, includes special alarms which indicate a number of religious events, and finally includes normal alarm functions. The above events are different and specific for a given geographical location in the sense as its sunrise and sunset times differ from another location.

There are several clocks having a certain number of additional features or functions like the well known pendula with various ornamental shapes presenting figures or even moving representations at predetermined times of the day. These actions are usually performed at full or half hours of the day primarily to delight the spectator or listener without any further function. Also, these functions usually are limited to very restricted changes in its occurrence, these normally happening only due to manual interventions. However, it isn't current to include a complex set of functions serving to bring certain events during the course of the day to the users attention into a clock, although its usually voluminous case could easily house corresponding devices. Nor it is conventional to foresee an easy-to-use, flexible and in certain aspects automatic way of setting up and maintaining the correct functioning of the clock including its additional functionality.

The need of a complex arrangement of functions in a clock emanates for example from corresponding habits of the user during the course of the day, which may be governed, especially in Islamic countries, by a detailed rhythm prescribed by the users religion. A simple wakeup alarm clock wouldn't arrange such a user for organising the daily agenda but a more complicated clock offering the possibility to enter a plurality of a kind of alarm functions, preferably in connection with specific actions of the clock indicating the type of alarm and stimulating the user to perform himself certain actions like a prayer, would be necessary.

The aim of the present invention consists in trying to remedy the above-mentioned inconveniences.

Therefore, the object of the present invention is a prayer clock comprising means adapted to recall the arise of certain events during the course of the day like especially for praying, this being accompanied by activating audio and/or visual means, the clock being flexible in its set up as well as in its handling, and its complex functionality moreover being steered by a computer like unit. The invention is characterised by the characteristics mentioned in claim 1, further advantages result from the characteristics expressed in the dependent claims and in the description exposing the invention in the following with reference to the figures in more detail.

The annexed figures represent, as an example, one embodiment of the invention.

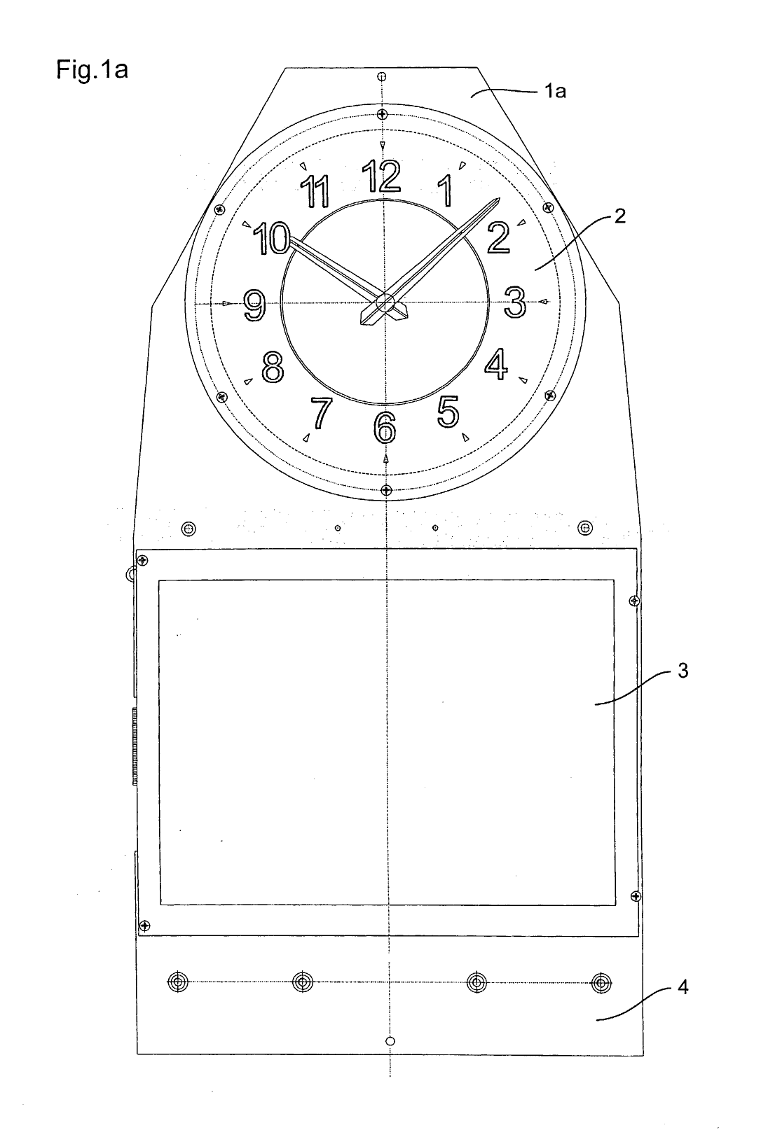

FIGS. 1a and 1b are schematic views of the clock from the front and back side.

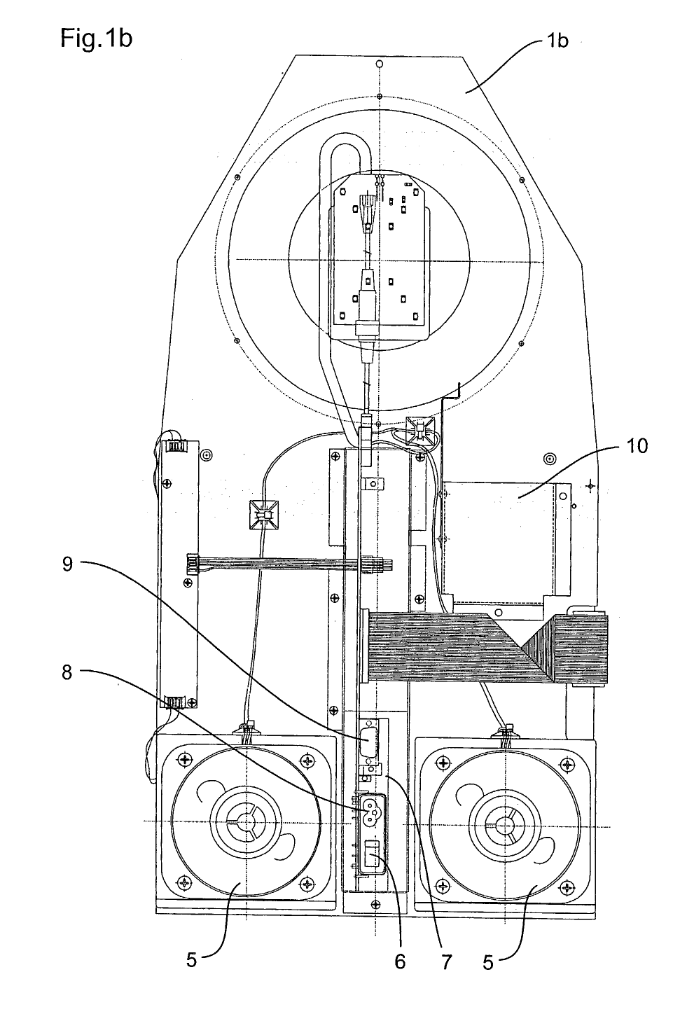

FIGS. 2a and 2b show examples of display modes of the secondary display unit.

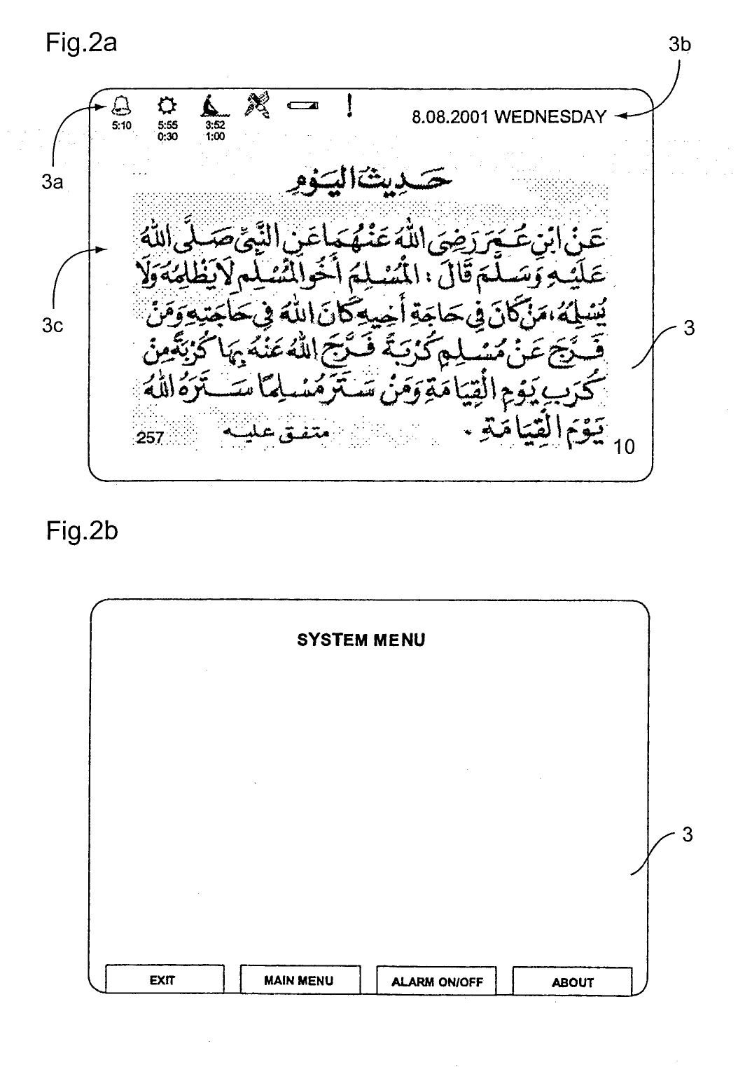

FIG. 3 schematically illustrates the main components of the clock.

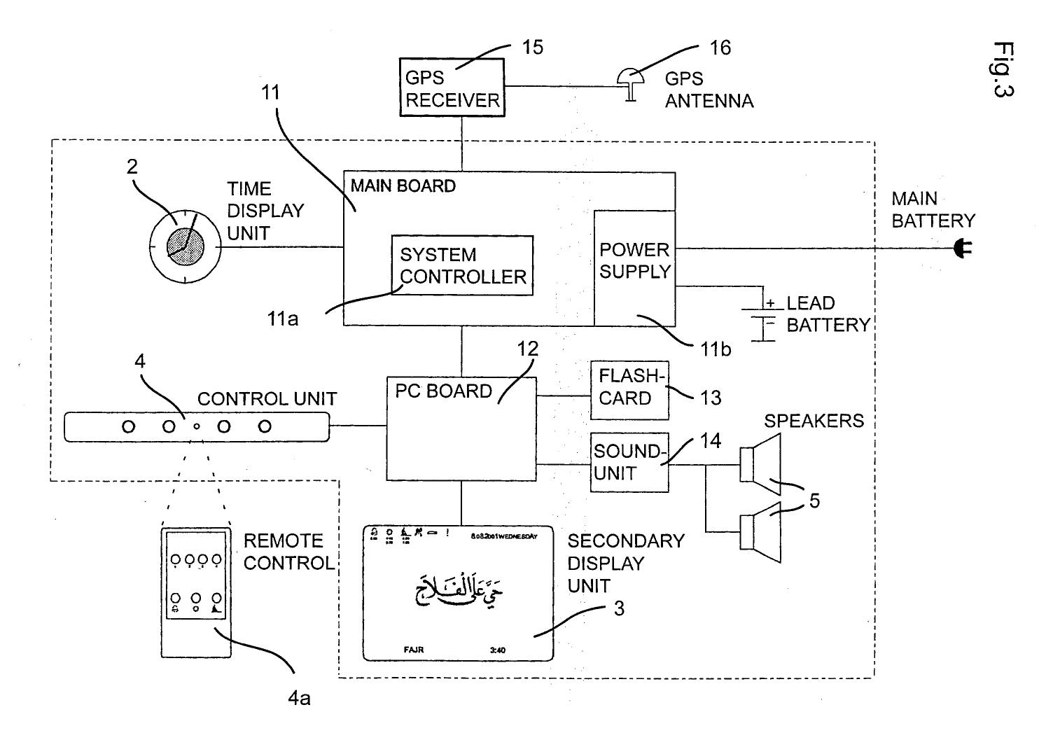

FIG. 4 indicates the events to be signalled by the prayer clock for the given application.

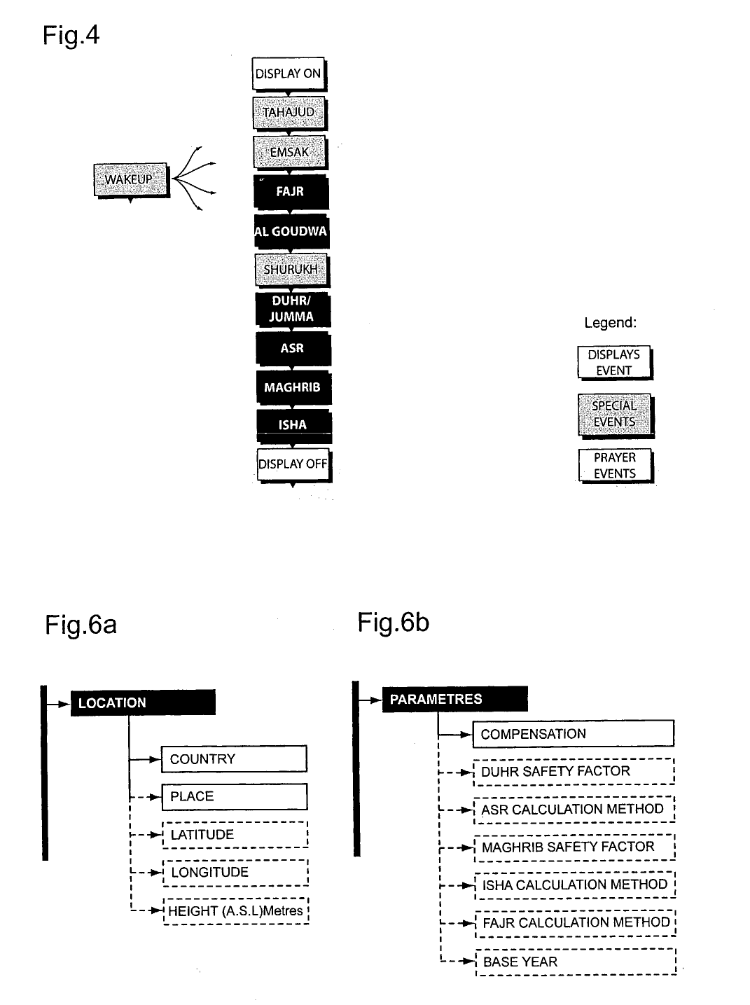

FIG. 5 schematically illustrates the two sources of prayer times.

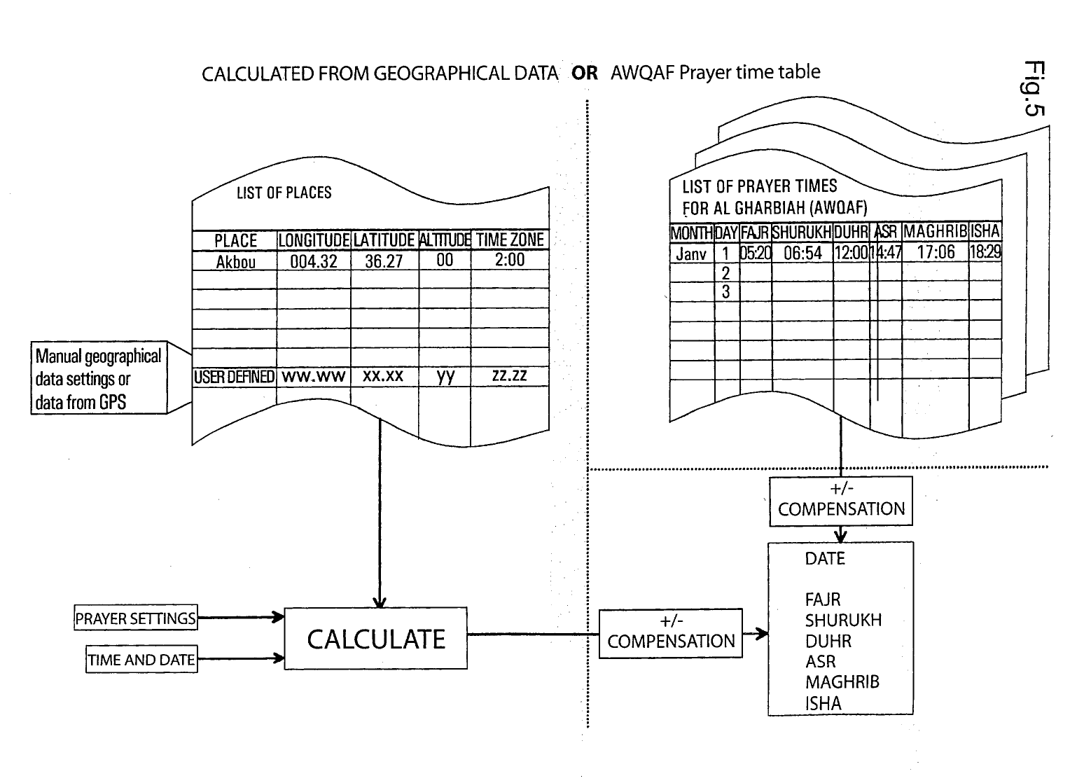

FIGS. 6a and 6b indicate the values to define the location and the prayer time calculation.

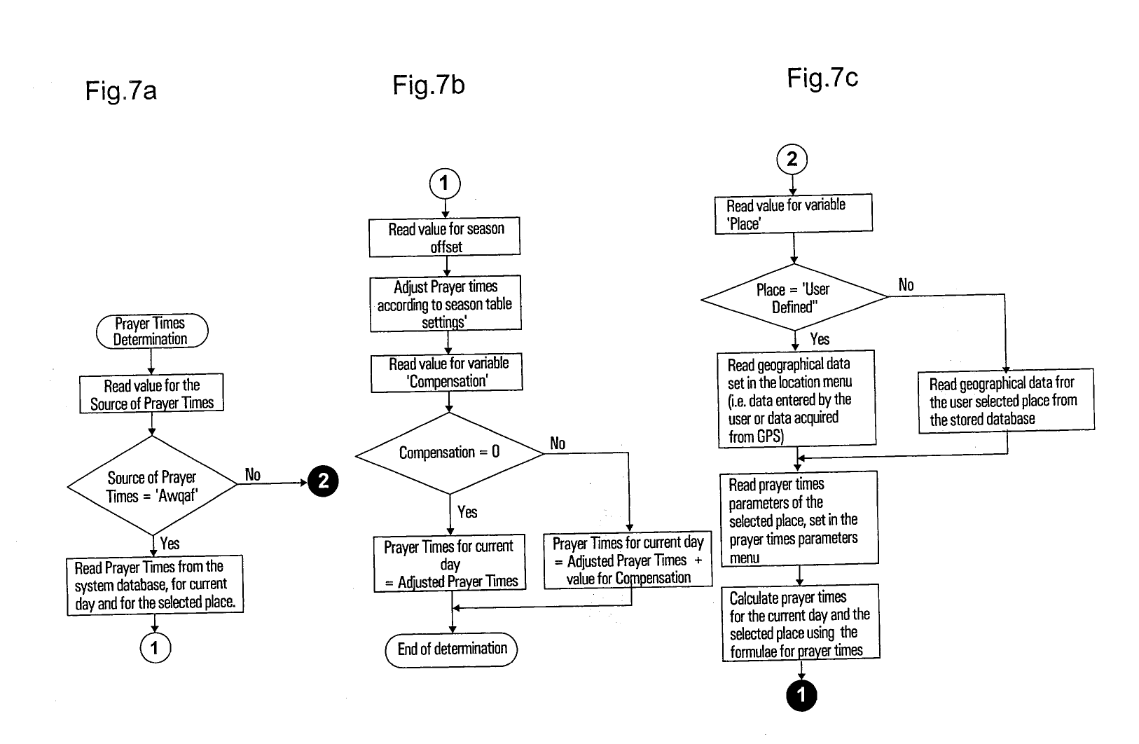

FIGS. 7a, b and c are schematic overviews of the steps of the procedure for determining the prayer times.

In the following, one example of an embodiment of a clock according to the present invention will be described in detail.

A prayer clock according to the present invention comprises a case 1 housing all the components and typically having dimensions in the order of a nowadays personal computer or a radio receiver unit, thus easily permitting to house the different components and to ascertain a convenient visibility of the display units. With reference to FIG. 1a one remarks, that a front cover 1a of the case 1 comprises a time display unit 2 with an hour and a minute hand, eventually also with a second hand, this unit preferably being an analogue display situated in the upper section of the front cover 1a. This time display unit 2 serves to indicate the local time in a clear and easily legible manner, and is equipped with a lamp illuminating the display in the dark.

The front cover 1a furthermore comprises a secondary display unit 3 as a visual display means and a control unit 4, the latter one preferably being situated below the secondary display unit 3 in the lower part of the front cover 1a. The secondary display unit 3, which usually will be a digital display and may be realised as a TFT or DSTN screen, is adapted to indicate a number of different messages corresponding to the various functions of the prayer clock and its functionality will be explained in more detail in one of the following sections, as well as the functioning of the control unit 4 which comprises a number of keys, e.g. in the form of foil keys, also corresponding to certain functions of the clock and serving to set up or modify the settings of the clock. This control unit is usually equipped with an infrared receiver unit in order to allow remote control.

Furthermore the clock comprises speakers 5, preferentially at the back cover 1b like illustrated schematically in FIG. 1b, serving as audio means to work solely or in combination with the secondary display unit 3 as visual means. A power switch 6 and power LED 7 visually indicating its on/off position are integrated in the back cover 1b as well as the mains plug 8 and alternatively, in some cases upon necessity, a GPS/DCF-interface 9 or a connection to a GPS antenna. Of course, some of these components and especially the speakers 5 can however be placed at the front cover 1a or the side cover, too. A backdoor 10 is integrated in the back cover 1b in order to have easy access for servicing and battery changes, a battery being included in the clock in order to ascertain power supply in case of a main power failure.

The secondary display unit 3 serves as visual communication means during set up and during maintaining or modifying the system, for indicating the different functions of the clock in general and during normal running as well as for presenting information relative to the function actually in operation. It can therefore be operated in different modes and can be used in a flexible manner, e.g. divided into different sections in order to indicate the information to be displayed in the according mode in a structured manner. Thus, in normal mode the secondary display unit 3 shows, like illustrated in the example of FIG. 2a, the status of the different alarms in a first display section 3a, the date and day in a second display section 3b and a religious text like an adage corresponding to the prescriptions of the Quran or texts having religious meanings for the day concerned in a third display section 3c. In the event mode, i.e. during the operation of an alarm, the display indicates the type of the alarm as well as the starting time of the alarm concerned or other related information, and, like illustrated in FIG. 2b, in the menu mode for setting up the clock or for modifying an alarm it indicates the varying functions of the keys of the control unit 4 situated just below the secondary display unit 3 as well as the menu options available for choice during the actual step. The secondary display unit 3 having a relatively large energy consumption, it of course disposes of a power save mode, e.g. during night. The speakers can be used to give simultaneously a corresponding acoustic signal to the user, like a wakeup signal for the simple wakeup alarm, or the recital of said adage during an event, etc.

Apart from the visible parts located on the case 1 having been described in the previous sections, a clock according to the present invention further comprises a number of important components including the necessary electronics, an overview of which as well as the interconnection of the main parts being schematically represented as a block diagram in FIG. 3. The central part consists in a main board 11 containing a system controller 11a and being connected to a power supply unit 11b as well as to the above mentioned battery for the case of a main power failure.

The main board 11 is also connected to a PC board 12, which comprises a processor and a RAM memory. The PC board itself is connected to a flash card 13 providing memory for storing necessary software and data, to a sound unit 14 addressing the speakers 5, usually via a graphic chip to the secondary display unit 3 and to the control unit 4. It is important that the flash card 13 is easily exchangeable due to its fast accessibility by the backdoor 10, enabling thus a fast change of some parts of the configuration of the clock, as this flash card contains information like application software, system data, text and sound information for the alarms respectively the events or the operating system. As being equipped with an infrared receiver unit like mentioned before, the control unit 4 can communicate with a remote control unit 4a in order to allow both modes of controlling the clock by the foil keys directly on the clock or by remote control.

The main board 11 also controls the analogue time display unit 2 by transmitting the corresponding time information.

It especially comprises a connection to an external position and/or time reference unit by means of a GPS/DCF-interface 9 permitting to connect the clock to a GPS receiver 15 which is itself connected to a GPS antenna 16. The receiver 15 and the antenna 16 can of course be chosen amongst various different models. Of course, it is also possible to house the position and/or time reference unit inside the clock case 1 and thus integrate an internal position and/or time reference unit including the necessary interfaces into the clock which makes it possible to omit the GPS/DCF-interface 9 at the clock case 1 and to replace it by a connection for a GPS antenna 16 if the latter one isn't integrated into the clock as well. Independent of the explicit realisation of the position and/or time reference unit, this configuration allows to directly determine the time, date and geographical position consisting of longitude, latitude and altitude at the place of the clock with regard to a reference unit, for example via the GPS system, provided that there is sufficient coverage by satellites.

Altogether, the parts of the clock and their connection as described in the previous sections, this allows to realise a complex set of functions for the prayer clock according to the present invention. By providing these functions the clock is adapted to recall a certain number of events during the course of the day, for example for praying, accompanied by audio and/or visual means, the clock being flexible in its set up as well as in its handling, and its complex functionality moreover being steered by a computer like unit. The functionality adapted specifically for Islam will now be described in more detail in order to specify one possible implementation of the arise of these alarms or events during the course of the day. One should nevertheless keep in mind that the definition of these alarm remains completely arbitrary and could be adapted to other religions or applications of another type requiring the signalling of several points of time during the day, shall these be in connection with each other or not, by a procedure corresponding to the present invention.

In the case described by the following sections, the prayer clock primarily serves to signal to its user the praying times during the course of the day according to rules stipulated in the Islamic religion.

Islam designates a certain number of times during the day at which prayers should be performed. These prayers and thus the corresponding times can have different importance, moreover voluntary prayers that can be performed during certain periods of the day but at the same time are prohibited at other periods of the day may be worthwhile to be integrated into the functionality of the clock and therefore require a high flexibility of the options of the prayer clock according to the invention. The meaning of these prayers or other events to be signalled to the user of the clock will have a significant influence on the detailed realisation of the clock and especially its specific functions initiating corresponding actions, but shall be described here only in the absolute minimum necessary for the understanding of the underlying principle of the present invention, an analogous detailed realisation of which can of course be tuned accordingly to similar applications. The designated praying events called Fajr, Duhr, Asr, Maghrib and Isha occur every day, corresponding for example to morning, midday, afternoon, sunset and evening prayer. Additional voluntarily praying events, like for example Tahajud, or other events, like for example Emsak, Al Goudwa and Shurukh, as well as simple alarm functions can be desired by the user. The prayer clock according to the present invention provides an alarm for the standard times for praying mentioned above. Moreover, the additional events may be switched on and off as well as a simple wakeup alarm. As mentioned above, the user will be alerted at the occurrence of these events by an acoustic signal from the speakers 5, e.g. by playing the so called Azan (call for praying), and/or by visual information related to the actual event being displayed at the secondary display unit 3, e.g. the Arabic (English, French, etc.) text of the prayer to be observed.

An overview of the events occurring during a day and their sequence, for the given specific example, can be seen in FIG. 4. Due to the specific type of these events being prescribed by the Islamic jurisprudence, interconnections between these events like for example one event occurring at a certain time before or after another, have to be included in the functionality of the clock, as well as the way of determining the point of time for the occurrence of these events and the actions to be performed for each event, which apparently have to be different and in accordance with the meaning of the event to the user with regard to his religion.

A specifically important point is the determination of the time during the day at which the alarms or events occur. Different methods can be used for this determination, dependant on the type of alarm, i.e. its religious meaning.

In the case of a simple time shift between two alarms, which is typically the case for the special alarms like for Tahajud occurring a certain period of time before the Fajr morning prayer or Al Goudwa which is occurring a certain period of time before sunrise, this necessity can easily be integrated and the clock allows to choose a period of time in the limits allowed by the prescriptions for the alarms concerned in order to define the occurrence of these alarms relative to the reference event.

Generally, the time of occurrence of a certain prayer or other event however is more complicated than a simple time shift and requires care. Primarily it depends on the location as well as on the season of the year. Moreover several methods and corrections may be applied, which however will not be described here in detail.

To cope with the dependence on location and season of the year, a clock according to the present invention offers two different solutions.

Firstly it comprises a database usually stored in the flash card 13. Like indicated at the left side of FIG. 5, this database comprises a list of places around the world, especially cities inhabited by a large number of Moslems, and contains for each place the information relevant for the application like longitude, latitude, altitude and time zone. Moreover the database contains, like indicated at the right hand side of FIG. 5, for a great number of these places a corresponding list of prayer times, this list stating for each day of the year the occurrence of all the praying and other events to be signalled by the prayer clock. The provenance of these praying times being an Islamic authority called Awqaf fixing these times according to Islamic jurisprudence, the clock therefore automatically has the correct times stored in its system for all users situated at one of the places being part of said list of places. After indicating the location and the actual time during set up, the prayer clock therefore is ready for signalling the requested alarms correctly for the indicated location if this one is contained in the database.

Secondly a prayer clock according to the present invention can also determine the prayer times for any given location by applying the prayer times formulae emanating from the rules of Islam and using the geographical data. These latter ones can be communicated to the system by either of three ways, firstly, can simply be the ones stored in the above mentioned list of places, or secondly, can be delivered to the clock manually using the control unit 4, or thirdly, can be acquired by means of an internal or external time and/or position reference unit like the GPS receiver 15. In this case, the location defined by its coordinates longitude and latitude and its altitude will be used by the clock to directly calculate the prayer times corresponding to the given place according to the regulations of Islam. The dependence of the prayer times on the season of the year, for example due to the varying time of sunrise and sunset, is taken care of by said calculation incorporating the above mentioned relevant regulations. These are common knowledge in Islamic countries and shall not be repeated at this place. Therefore the praying times of any location can be determined by the prayer clock, provided that the geographical data of that location and the actual time are entered to it. As mentioned above, a GPS receiver 15 as an example of a time and/or position reference unit can be directly connected to the prayer clock delivering the necessary information, or these data can be entered manually using the control unit 4.

A graphical representation of these steps can be found in FIG. 6. The prayer time setting incorporates the steps of defining the location and of choosing the above described way of determining the prayer times. FIG. 6a shows the first step of defining the location, where the definition of the elements in the line boxes always take place whereas the elements in the dotted boxes only take place in case the prayer times should or have to be calculated and thus the coordinates and the altitude need to be entered or eventually to be corrected (manually). The second step of choosing the table values for the prayer times stored in the database or calculating these by using said geographical information comprises the definition of some parameters shown in FIG. 6b. These parameters represent the above mentioned options during the calculation of the prayer times due to different methods of these calculations in different countries or different branches of Islam. A compensation in the sense of a small time shift of all/each prayer times due to only an approximate location of the clock close to a place available in the database can be done for both choices. The other parameters will only be defined in case the calculation method was chosen by the user instead of taking the table values from the database and correspond to different possibilities of calculating the prayer times, for example by using a twilight angle or astronomical values, etc. in the calculation, allow for safety factors and thus enable in general to include the various methods in Islam to determine the prayer times. Of course, also simple corrections due to summer time or similar season offsets in different countries are integrated and can be communicated to the system of the clock by a submenu via the control unit 4.

Once the location and the way of determination of the prayer times including its parameters have been defined, the procedure of determining these prayer times can be represented like shown in the flow charts in FIGS. 7a-c, which give a graphical summary of the preceding explanations.

In a final section the actions of the prayer clock at the occurrence of an alarm shall be described. As already mentioned above, the user will be alerted at the occurrence of one of these events by an acoustic signal from the speakers 5 and/or by visual information concerning the actual event being displayed at the secondary display unit 3. Such an acoustic signal can for example consist in playing the Azan (call for prayer), in a recital of a verse of the Quran and/or a religious verse corresponding to the actual event or a simple beep as a wakeup signal. The visual information displayed at the secondary display unit 3 can be a text of the prayer to be observed, the verse or the adage relevant to the event, simply the name of the event or alarm as well as additional information like the time elapsed since the beginning of the event or till the next event or a certain parameter having been set for or an icon representing the alarm concerned. Of course, these acoustic and visual signals can be realised by a large variety of different possibilities serving however always for the same purpose of alerting the user and informing him on the event to be observed.

The preceding description of a prayer clock according to the present invention gives rise to the statement that such a device is adapted to signal the occurrence of a plurality of alarm events thanks to a complex functionality. The individual occurrence time of each alarm or event can be determined although its dependence on location and course of the year in an easy and automatic manner, thus presenting numerous advantages to the user like a simple set up and handling combined with a multifunctionality offering diverse options of configuration and for normal running mode in order to obtain convenient signalling of all necessary events.

1. Clock comprising a time display unit (2) with an hour and a minute indication and a control unit (4) characterised by the fact that it comprises means for signalling a plurality of times of occurrence of certain events during the course of the day and by the fact that it comprises means for determining the occurrence times of said events dependent on information related to a given location.

2. Clock according to claim 1 characterised by the fact that said means for determining the occurrence times of said events to be signalled comprise means for storing information on a great number of locations and information on the times of occurrence of said events directly in the clock.

3. Clock according to claim 1 or 2 characterised by the fact that said means for determining the occurrence times of said events comprise a flash card (13) which contains a database relating geographical information on a great number of locations with the corresponding information on the occurrence times of said events to be signalled by the clock.

4. Clock according to one of the claims 1 to 3 characterised by the fact that the control unit (4) is adapted to allow to enter geographical information on the location.

5. Clock according to one of the claims 1 to 4 characterised by the fact that it comprises means for connecting an internal or an external position and/or time reference unit.

6. Clock according to the preceding claim characterised by the fact that the clock comprises a GPS/DCF-interface (9).

7. Clock according to one of the claims 5 or 6 characterised by the fact that the internal or external position and/or time reference unit comprises a GPS receiver (15) and a GPS antenna (16) integrated in or connected to the clock and delivering geographical and/or time reference data to the clock.

8. Clock according to one of the preceding claims characterised by the fact that said means for determining the occurrence times of said events comprise means for calculating said times of occurrence of the events to be signalled according to known formulae governing these times and taking into account geographical information related to a location and acquired by or stored in the clock.

9. Clock according to the preceding claim characterised by the fact that the means for calculating the occurrence times are adapted to communicate with an internal or external position and/or time reference unit in order to acquire the necessary geographical information.

10. Clock according to claim 8 or 9 characterised by the fact that the means for calculating the occurrence times are adapted to communicate with means for storing information situated directly in the clock in order to acquire the necessary geographical information.

11. Clock according to one of the claims 8 to 10 characterised by the fact that the means for calculating the occurrence times are adapted to communicate with the control unit (4) in order to acquire the necessary geographical information.

12. Clock according to one of the claims 8 to 11 characterised by the fact that the means for calculating the occurrence times are adapted to perform several methods of calculation of these times dependant on a number of parameters.

13. Clock according to one of the claims 8 to 12 characterised by the fact that the means for calculating the occurrence times comprise a main board (11) and a PC board (12).

14. Clock according to claim 13 characterised by the fact that the main board (12) comprises a system controller (11a) and a power supply (11b).

15. Clock according to one of the preceding claims characterised by the fact that the means for signalling a plurality of times of occurrence of certain events during the course of the day comprise a secondary display unit (3).

16. Clock according to the preceding claim characterised by the fact that the secondary display unit (3) is adapted to be used also during set up and modifying the configuration of the system of the clock.

17. Clock according to one of the claims 15 or 16 characterised by the fact that the secondary display unit (3) is a TFT or DSTN display.

18. Clock according to one of the claims 15 to 17 characterised by the fact that the means for signalling a plurality of times of occurrence of certain events during the course of the day comprise acoustic means (5).

19. Clock according to the preceding claim characterised by the fact that the acoustic means (5) and a secondary display unit (3) are adapted to be driven by a PC board (12) in an independent or in a coherent manner in order to signal the occurrence of an event to be signalled by the clock.

20. Clock according to one of the preceding claims characterised by the fact that the control unit (4) is adapted to communicate with a remote control unit (4a).

21. Clock according to one of the preceding claims characterised by the fact that said means for signalling a plurality of times of occurrence of certain events during the course of the day are adapted to signal at least five different events during the course of the day.
